(19) United States
(12) Patent Application Publication
(10) Pub. No.: US 2006/0045009 A1
(43) Pub. Date: Mar. 2, 2006

(54) Device and method for managing oversubsription in a network

(76) Inventors: Ken Madison, Santa Clara, CA (US); Poly Palamuttam, San Jose, CA (US); Ravinder Sajwan, Saratoga, CA (US); Mathew Steinberg, Livermore, CA (US); Marek Tlalka, Fremont, CA (US)

Correspondence Address: ANTHONY DELAS, 3333 BOWERS AVE #130, SANTA CLARA, CA, 95054, US

(21) Appl. No.: 10/930,267

(22) Filed: Aug. 30, 2004

(51) Int. Cl. H04L 12/26

(52) U.S. Cl. 370/229

(57) ABSTRACT

A device and a method for aggregating and managing large quantities of data are disclosed. The received data are prioritized into high and low priority queues. The device receive memory is partitioned into 1 Kilo byte (1 KB) blocks which are further divided into free list and allocation list. The low priority queues occupy between 1 and 48 blocks and the high priority queues occupy between 1 and 32 blocks. The incoming data are further subjected to Weighted Random Early Detection (WRED) process that controls congestion before it occurs by dropping some of the queues. The stored data are read using Modified Deficit Round Robin (MDRR) approach The transmit memory operates with 240 1 KB blocks and the data is transmitted out via an SPI 4.2 or similar device.

### FIELD OF THE INVENTION

The invention relates to the field of data transmission from multiple sources and more specifically to managing data when an Ethernet network is oversubscribed.

### BACKGROUND OF THE INVENTION

It is quite common to have a data network operate at less than its full capacity, typically around 50% utilization. This is due primarily to the “bursty” nature of the data being transmitted. This is quite costly and methods have been developed to better utilize the available capacity. One approach oversubscribes the system by some factor and exploits the fact that many users will not be utilizing the system all at the same time, thus having sufficient capacity available under most conditions. This approach allows the designer to play the “averages” by assigning the information processing rate to a port that is greater than the speed of the port. The approach is attractive as it saves the costs of the port connections, typically a significant portion of the total system cost. However, to successfully implement such approach, one requires historic information about the network usage, such as that obtained from actual system measurements.

Oversubscription has been successfully tried in WAN networks, voice transmission such as PBX networks, ATM equipment, etc. Similarly, in the Ethernet data transmission, it can be expected that different users will require higher rate of utilization at different times, thus creating an opportunity to employ oversubscription, improve the system utilization and reduce the overall costs. For this approach to succeed, it must not sacrifice the quality of service the end user expects, and therefore, must avoid congestion, minimize packet drops and provide proper handling of high priority traffic. The device of this invention meets such requirements.

### SUMMARY OF THE INVENTION

An embodiment of the present invention aggregates large quantity of data and manages an oversubscribed data transmission system. The data enters the device from an 8 port Physical Layer (PHY) by the way of a Reduced Medium Independent Interface (RMII) or Reduced Gigabit Medium Independent Interface (RGMII) through a Media Access Control (MAC) device. Up to three 8 port PHY devices may be used. The incoming data are then classified into high and low priority according to the priority level contained in their virtual Local Area Network (vLAN) tag. The prioritized data are then processed through Weighted Random Early Detection (WRED) routine. The WRED routine prevents congestion before it occurs by dropping some data and passing other according to the pre-determined criteria. The passed data are written into the memory that is divided into 480 1 Kbyte (KB) buffers (blocks). The buffers are further classified into a free list and an allocation list. The data are written into the memory by the Receive Write Memory manager. Each port on the device of this invention accommodates a high priority queue and a low priority queue, with low priority queue being allocated up to 48 blocks and the high priority queue up to 32 blocks. The stored data are read by the Receive Read Memory Manager, with each port being serviced in round robin fashion, and within a port, high and low priority queues are serviced by using Modified Deficit Round Robin (MDRR) approach. The data are then transmitted out of the device via an SPI 4.2 or similar approach.
In this application, the terms data, frame, packet are used interchangeably

### BRIEF DESCRIPTION OF THE DRAWINGS

FIG. 1 shows the OSI reference model.

FIG. 2 is the block diagram of the invention.

FIG. 3 is the overall process flow chart.

FIG. 4 is Ethernet frame format with vLAN tag.

FIG. 4B shows the round-robin approach to enqueueing.

FIG. 5 is vLAN priority to queue mapping table.

FIG. 6 shows the WRED drop probability graph.

FIG. 7 is the frame drop behavior table.

FIG. 8 shows the MDRR approach.

### DETAILED DESCRIPTION

### Overview

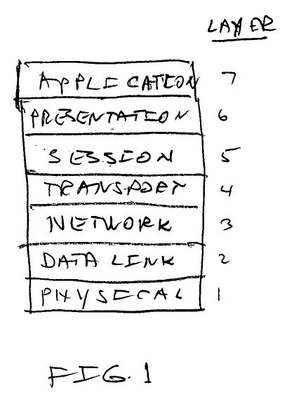

Many different types of hardware and software from a broad base of vendors are continually entering the communications market. In order to enable communications between such devices a set of standards has been developed. Shown in FIG. 1 is an International Standards Organization (ISO) reference model for standardizing communications systems called the Open Systems Interconnect (OSI) Reference Model. The OSI architecture defines the communications process as a set of seven layers, with specific functions isolated and associated with each layer. The layer isolation permits the characteristics of a given layer to change without impacting the other layers, provided that the supporting services remain the same. Each layer consists of a set of functions designed to provide a defined series of services.

Layer 1, the physical layer (PHY), is a set of rules that specifies the electrical and physical connections between devices. This level specifies the cable connections and the electrical rules necessary to transfer data between devices. It typically takes a data stream from an Ethernet Media Access Controller (MAC) and transforms it into electrical or optical signals for transmission across a specified physical medium. PHY governs the attachment of the data terminal equipment, such as serial port of personal computers, to data communications equipment, such as modems.

Layer 2, the data link layer, denotes how a device gains access to the medium specified in the physical layer. It defines data formats, including the framing of data within transmitted messages, error control procedures, and other link control activites. Since it defines data formats, including procedures to correct transmission errors, this layer becomes responsible for reliable delivery of information.

Layer 3, the network layer, is responsible for arranging a logical connection between the source and the destination nodes on the network. This includes the selection and management of a route for the flow of information between source and destination, based on the available data paths in the networks.

Layer 4, the transport layer, assures that the transfer of information occurs correctly after a route has been established through the network by the network level protocol.

Layer 5, the session layer provides a set of rules for establishing and terminating data stream between nodes in a network. These include establishing and terminating node connections, message flow control, dialogue control, and end-to-end data control.

Layer 6, the presentation layer, addresses the data transformation, formatting, and syntax. One of its primary functions of this layer is the conversion of transmitted data into a display format appropriate for a receiving device.

Layer 7, the application layer, acts as a window through which the application gains access to all the services provided by the model. This layer typically performs such functions as file transfers, resource sharing and database access.

As the data flows within a network, each layer appends appropriate heading information to frames of information flowing within the network, while removing the heading information added by the proceeding layer.

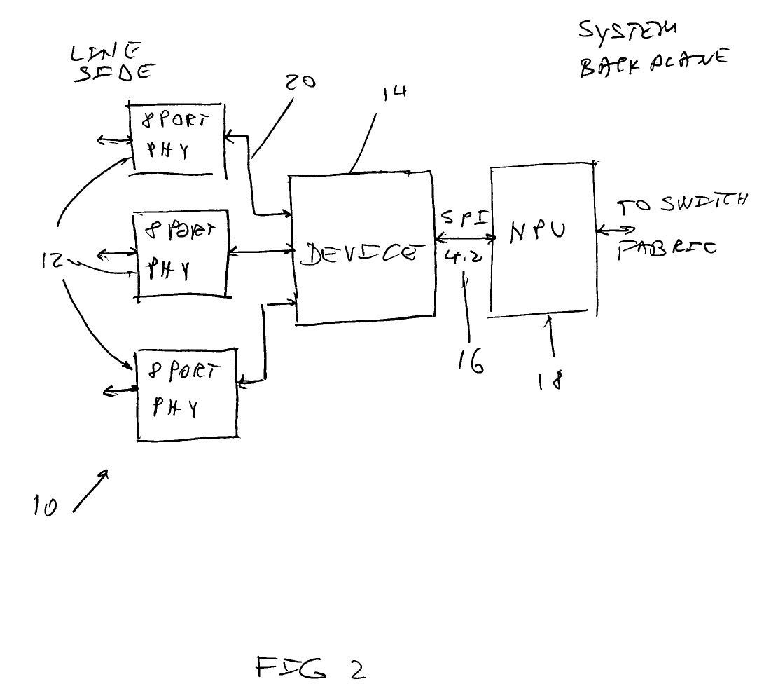

Shown in FIG. 2 is the over-all basic block diagram 10 of the interaction of the typical embodiment of the device of this invention 14 and other communications components. The data enters form the line side via a PHY 12 device (ingress) and may flow bi-directionally. In this case PHY 12 is an 8 Port device capable of operating at 10 Mega bits per second (Mbps), 100 Mbps or 1 Giga bit per second (Gbps) for each port, resulting in a total of 24 Gbps for 24 ports. The information from the PHY 12 is transmitted to the device 14 via interface 20, typically Reduced Medium-Independent Interface (RMII) or Reduced Gigabit Medium-Independent Interface (RGMII). The device 14 aggregates the information from all 24 ports and transmits it to Network Processor Unit (NPU) 18 via System Packet Interface Level 4 Phase 2 (SPI 4.2) or a device of similar capability. Depending on the operating speed of SPI 4.2 or a device of similar capability and a particular RGMII mode used, e.g.1 Gigabits/sec, the device 14 may be oversubscribed by a ratio of up to 8:1 on the line side. The data is then directed from NPU 18 to suitable switch fabric on the system back-plane.

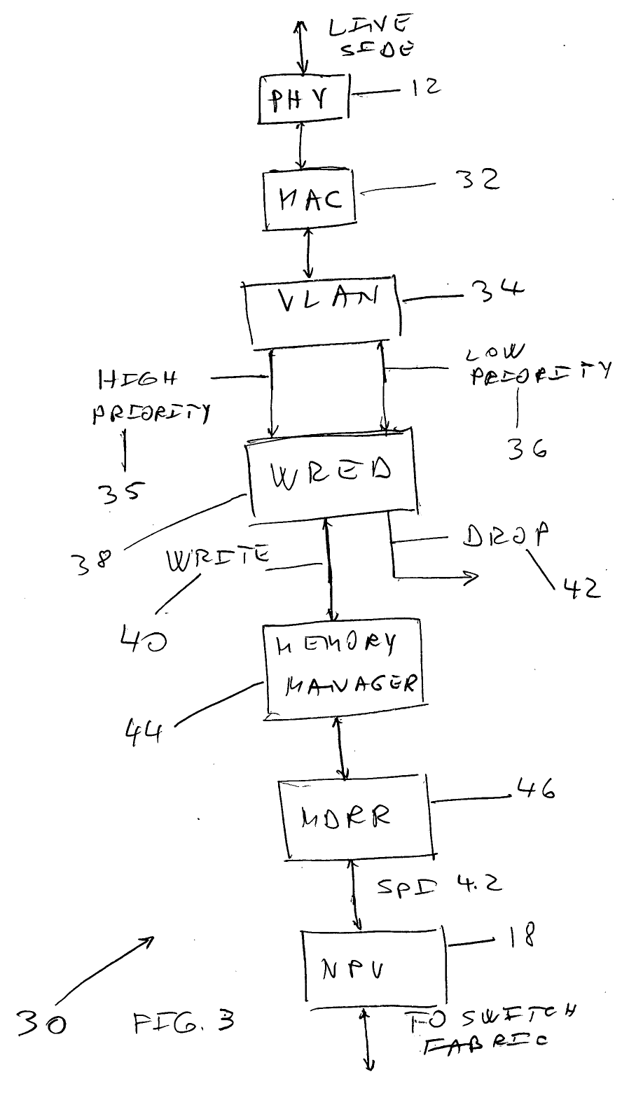

Shown in FIG. 3 is the general process flow chart applicable to each port for the data being transmitted between the PHY 12 and the switch fabric. The data enters the device 14 via a generally available Media Access Control Device (MAC) 32. The MAC 32 may be integrated with the device 14 or it may be a separate unit. In general terms MAC 32 or a similar device is employed to control the access when there is a possibility that two or more devices may want to use a common communication channel. In this embodiment device 14 employs up to 24 MACs 32.

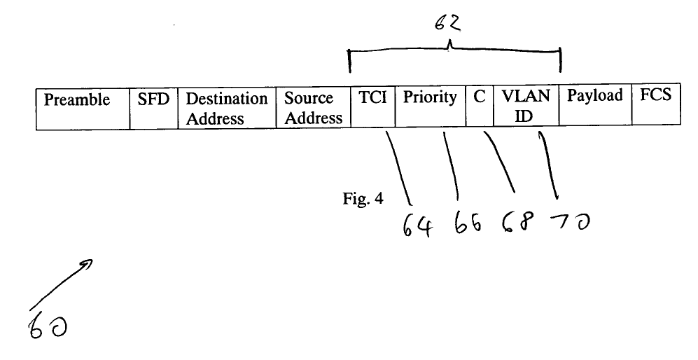

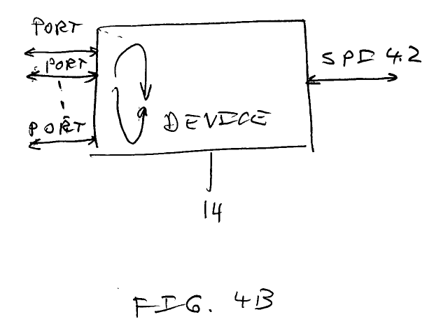

The Ethernet data stream is typically transmitted to the ingress side of device 14 in Ethernet frame format 60 with a virtual Local Area Network (vLAN) tag 62 shown in FIG. 4. The Ethernet frame 60 conforms with IEEE 802.1Q frame format. The primary purpose of the vLAN tag 62 is to determine the priority of the incoming data traffic based on Class of Service (CoS) and classify it accordingly. The components of the vLAN tag 62 are: Tag Control Identifier (TCI) 64, Priority filed 66 (typically 3 bits of data per IEEE 802.1p standard), Canonical Format Identifier 68 and vLAN identity information 70 (typically 12 bits of data). Generally, the vLAN 62 makes it appear that a set of stations and applications are connected to a single physical LAN when in fact they are actually not. The receiving station can determine the type of the frame and correctly interpret the data carried in the frame. One with skill in the art would be able to program the type of routine needed to retrieve this information. To properly identify the type of the frame received, the value of the bits following the source address is examined. If the value is greater than 1500, an Ethernet frame is indicated. If the value is 8100, then the frame is IEEE 802.1Q tagged frame and the software would look further into the tag to determine vLAN identification and other information.

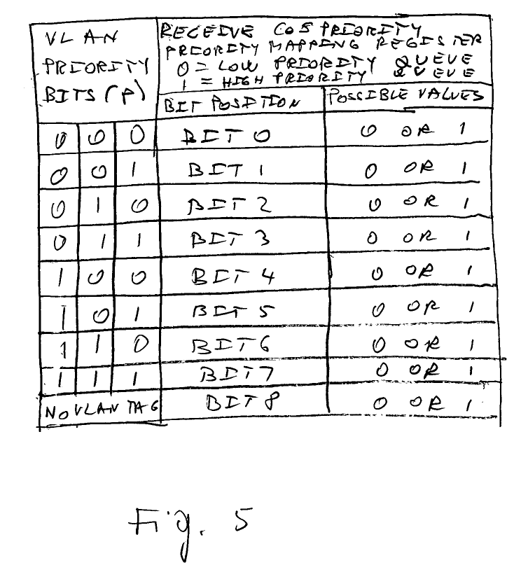

All ingress ports are scanned in round robin fashion resulting in an equitable process for selecting ports for enqueueing, i.e. for entering the device 14. This is shown in FIG. 4B. Multiple priority queues are associated with each port. Some queues are used for high priority traffic and some for low priority traffic. The over-subscription logic of device 14 obtains priority designation from the vLAN priority field 66 of the vLAN tag 62. The 3-bit vLAN priority field 66 indexes into a user programmable table that provides the lookup needed to determine the priority level. Typically, the upper four of the eight priority levels are mapped into a high priority queue and the lower four priority levels are mapped into low priority queue. If there is no VLAN 62 tag, all levels default to a single queue. FIG. 5 shows vLAN priority field 66 mapping table and the Class of Service (CoS) priority mapping register.

The device 14 also employs an IEEE 802.3-2000 compliant flow control mechanism. Each RGMII port with its MAC will perform independent flow control processing. The basic mechanism uses the PAUSE frames per the 802.3x specification. Each of the high and low priority queues associated with each port is programmed with a desired threshold value. When this value is exceeded, a PAUSE frame is generated and sent to a remote upstream node. The device 14 provides two different options for the PAUSE frame. In the first option, a 16-bit programmable timer value is sent in the PAUSE frame, this bit being used by the receiver as a pause quantum. No further PAUSE frames are sent. When the quantum expires, the transmission begins again. In the second option, the MAC sends a PAUSE frame when the threshold is exceeded and another PAUSE frame with a zero pause quanta when the buffers go below threshold signifying that the port is ready to receive data again.

An additional feature of the device of this invention found in the Layer 2 (Data Link Layer) is Weighted Random Early Detection (WRED) 38 (see FIG. 3) scheme, presently available in the art. Here, WRED is employed to limit the incoming data rate to avoid congestion by dropping some of the data packets per a predetermined criteria. In this scheme, frames are dropped with some probability if certain threshold is exceeded. Anticipating congestion and dropping frames early in this manner, congestion due to bursty traffic can be avoided.

Generally, Random Early Detection (RED) aims to control the average queue size by indicating to the end hosts when they should temporarily slow down transmission of packets. RED takes advantage of the congestion control mechanism of Transmission Control Protocol (TCP). By randomly dropping packets prior to periods of high congestion, RED communicates to the packet source to decrease its transmission rate. Assuming the packet source is using TCP, it will decrease its transmission rate until all the packets reach their destination, indicating that the congestion is cleared. Additionally, TCP not only pauses, but it also restarts quickly and adapts its transmission rate to the rate that the network can support. RED distributes losses in time and maintains normally low queue depth while absorbing spikes. When enabled on an interface, RED begins dropping packets when congestion occurs at a pre-selected rate.

### Packet Drop Probability

The packet drop probability is based on the minimum threshold, maximum threshold, and mark probability denominator. When the average queue depth is above the minimum threshold, RED starts dropping packets. The rate of packet drop increases linearly as the average queue size increases until the average queue size reaches the maximum threshold. The mark probability denominator is the fraction of packets dropped when the average queue depth is at the maximum threshold. For example, if the denominator is 256, one out of every 256 packets is dropped when the average queue is at the maximum threshold. When the average queue size is above the maximum threshold, all packets are dropped.

The minimum threshold value should be set high enough to maximize the link utilization. If the minimum threshold is too low, packets may be dropped unnecessarily, and the transmission link will not be fully used. If the difference between the maximum and minimum thresholds is too small, many packets may be dropped at once.

WRED 38 combines the capabilities of the RED algorithm with the Internet Protocol (IP) precedence feature to provide for preferential traffic handling of higher priority packets. WRED 38 can selectively discard lower priority traffic when the interface begins to get congested and provide differentiated performance characteristics for different classes of service. WRED 38 can also be configured to ignore IP precedence when making drop decisions so that non-weighted RED behavior is achieved.

WRED 38 differs from other congestion avoidance techniques such as queueing strategies because it attempts to anticipate and avoid congestion rather than control congestion once it occurs. WRED 38 makes early detection of congestion possible and provides for multiple classes of traffic.

By dropping packets prior to periods of high congestion, WRED 38 communicates to the packet source to decrease its transmission rate. If the packet source is using TCP, it will decrease its transmission rate until all the packets reach their destination, which indicates that the congestion is cleared.

### Average Queue Size

The average queue size is based on the previous average and the current size of the queue. The formula is:
average=(old average*(1-2⁻ⁿ))+(current queue size*2⁻ⁿ)
where n is the exponential weight factor, a user-configurable value. For high values of n, the previous average becomes more important. A large factor smooths out the peaks and lows in queue length. The average queue size is unlikely to change very quickly, avoiding drastic swings in size. The WRED 38 process will be slow to start dropping packets, but it may continue dropping packets for a time after the actual queue size has fallen below the minimum threshold (Kbytes). The slow-moving average will accommodate temporary bursts in traffic. For low values of n, the average queue size closely tracks the current queue size. The resulting average may fluctuate with changes in the traffic levels. In this case, the WRED 38 process responds quickly to long queues. Once the queue falls below the minimum threshold, the process will stop dropping packets. If the value of n gets too low, WRED 38 will overreact to temporary traffic bursts and drop traffic unnecessarily. If the average is less than the minimum queue threshold, the arriving packet is queued. If the average is between the minimum queue threshold and the maximum queue threshold, the packet is either dropped or queued, depending on the packet drop probability. If the average queue size is greater than the maximum queue threshold, the packet is automatically dropped.

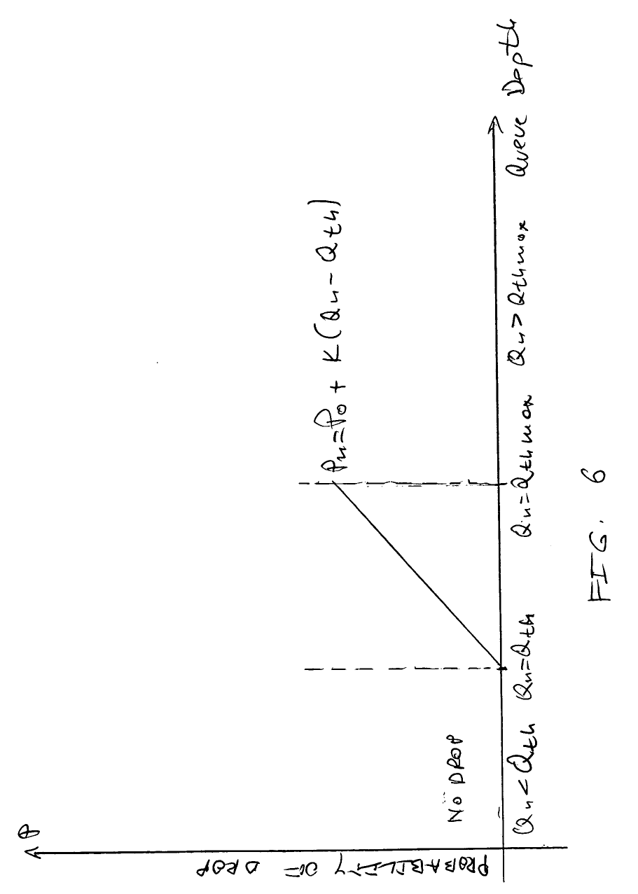

Specifically, WRED 38 provides up to four programmable thresholds (watermarks) associated with each of the two queues. Corresponding to four thresholds, four programmable probability levels are provided creating four threshold-probability pairs. This relationship is shown in FIG. 6, where Probability of Drop is given by the following expression:
Pₙ=P₀+K(Q_{wn}−Qₜₕ)
Pₙ=the new calculated probability
P₀=user programmable initial probability
Qₜₕ=the initial threshold level of the queue
Q_{wn}=the n level watermark
K=constant

The threshold is the value on queue level (queue depth) and the corresponding probability is the probability of dropping a frame if the corresponding threshold is exceeded. It is also possible to set thresholds on some ports to guarantee no frame drops. This option is possible for only a subset of ports operating in the 1 Gbps mode.

The value of constant K determines how big the probability of drop is for a given queue filling over the threshold Qₜₕ. One skilled in the art will be able to determine proper level of K for the specific application. The device 14 supports four programmable watermarks per queue and based on each level, Pₙ, the probability for drop is calculated for the next sequence. The frames which are not dropped are written into the device 14 memory, such memory being either internal or external to the device 14. The threshold for low and high priority queues are programmed in the device 14 registers. Here, the device 14 utilizes CfgRegRxPauseWredLpThr and Cfg RegRxPauseWredHpThr registers. Associated probabilities are programmed into registers: CfgRegRxWredLpProb and CfgRegRxPauseWredHpThr. A person skilled in the art will be able to properly define such registers.

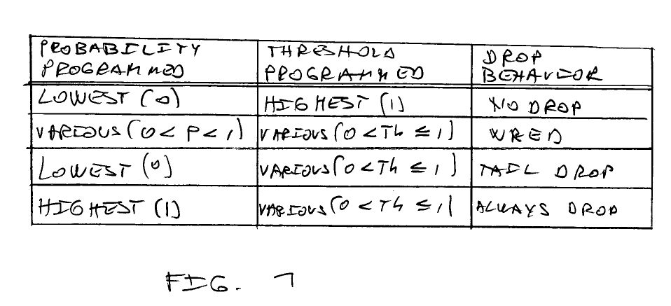

FIG. 7 shows combination of probability and threshold levels used and the corresponding frame drop behavior.

### Enqueueing Operation

Generally, frames enter from the RGMII interface into the MAC 32 receive side and are subjected to vLAN and WRED tests described above before writing into the receive memory located in the receive memory manager 44. Memory manager 44 is organized as a pool of preferably 1 Kbyte buffers (or blocks) for a minimum of 480 blocks in case of a 24 port device 14. The 1 Kbyte buffer size enables easy memory allocation from ports that have small amount or no data arriving to them to other ports that are more occupied and need the memory. The buffers can be further classified into an allocation list and the free list. Each port has two allocation lists, one is high priority queue and the other a low priority queue. The high priority queue can occupy between 1 and 32 blocks unless there is no priority mechanism and all packets fall into one queue. The low priority queue can occupy between 1 and 48 blocks. The size of the low priority queue is larger than the high priority queue because the high priority queue is serviced more frequently. The buffers are reserved as soon as the data transmission starts, i.e., as soon as vLAN tag has been read and the data is classified as high or low priority queue. The unoccupied buffers are kept in a free list and signify the amount of memory remaining after the total of 480 Kbytes have been decremented by the allocation list.

The receive memory operates at a frequency of 140 MHz making a total of 36 Gbps of bandwidth for writing and reading the data. The memory may be a dual ported RAM or a device with similar capabilities. This memory is sufficient to handle the case of all 24 ports running at 1 Gbps and SPI 4.2 running at full speed.

The data are written into the memory manager by Receive Write Memory Manager (RxWrMemMgr) that generally functions as follows:
Operates at 155 MHz system clock frequency.
Reads 32 bytes from each port in a round robin fashion.
Retrieves free buffers for the requesting ports from the free list.
Uses the priority information in the start of packet (SOP) inband control word to write into memory buffer.
Forms the address to write data read from the RxMacFifo (receive MAC, first in first out) into the memory by appending the pointer to memory buffer from the allocation list and the curr (current)_wr_ptr_curr_wr_offset incremented after every write. Increments EOP (end of packet) counter associated with each queue after writing in the last byte (Error/Valid EOP).
Uses the drop registers to decide on packet drops. When a number of buffers used per queue exceeds certain threshold, packets are dropped with fixed probability. The threshold and the probability are programmed in the four WRED registers associated with each queue. Drop is achieved by reading packets from the RxMacFifo but not writing them into the memory.

RxWrMemMgr employes the following basic data structure:
A 480 entry buffer list pointing to the start of each of the 480 Kbyte buffers (rx_free_list).
High (up to 32 entries) and low (up to 48 entries) allocation lists per port (rx_port_qh and rx_port_ql).
A current write offset into the current active buffer for each que (rx_curr_wr_offset).
A current read offset into the current active buffer for each queue (rx_curr_rd_offset).
A write pointer pointing to written buffers for the entry allocation list (rx_port_buffers_wrt_ptr).
A read pointer pointing to read buffers for the entry list (rx_port_buffers_rd_ptr).
A set of four Drop registers per port for setting thresholds for the WRED-like function. The registers contain threshold for the number of buffers used by the port and the probability associated with dropping a packet for that particular threshold. An EOP (end of packet) counter associated with each queue that is incremented whenever a complete packet is written into the memory.
   Functions:

A pop function that looks at the address of free buffer(s), free_list, sends that information to the requesting port and returns a pointer to a free buffer to the requesting port.

function pop 0;
{
return (ptr_to_free_buff);
}

A push function that returns the used buffer to the free_list from logic:

function push (ptr_to_used_buffer;)
{
return (status);
}

A read scheduler (arbiter-arb) that returns next port to be read from:

function next_port (input req [(0:23])
{
return (next_port_to_read);
}

### Dequeueing Operation

The Receive Read Memory Manager is responsible for de-queueing data from the 48 (24 high priority and 24 low priority queues) and it operates at 155 MHz system clock frequency. Ports are serviced in a round robin fashion, however, within a port, high and low priority queues are serviced using commercially available MDRR 46 (Modified Deficit Round Robin) based approach.

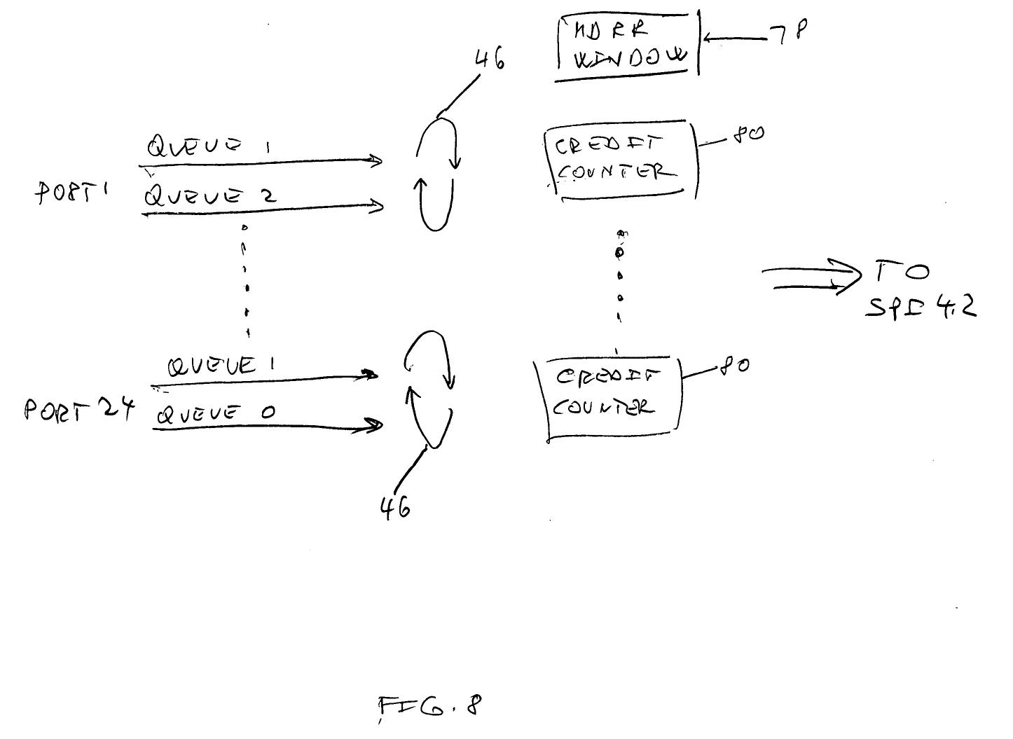

The MDRR 46 approach provides fairness among the high and low priority queues and avoids starvation of the low priority queues. Complete Ethernet frames are read out from each queue alternatively until the associated credit register reaches zero or goes negative. The MDRR 46 approach assigns queue 1 of the group as low latency, high priority (LLHP) queue for special traffic such as voice. This is the highest priority Layer 2 CoS queue. LLHP queue is always serviced first and then queue 0 serviced. A configurable credit window 78 and credit counter 80 shown in FIG. 8 are added for each high and low priority queues. The credit window 78 sets the maximum bound for dequeueing for the port. The credit counter 80 represents the number of 16-byte transfers available for the queue for the current round. The credit counter 80 is checked at the beginning of the service and if the credit count is positive, the queue is serviced. If the credit count is zero, but the queue contains at least a maximum burst 1 or maximum burst 2 bytes the queue will be serviced. Once a queue is serviced a fixed amount of programmable credits are added to the queue. The only time a queue will not be serviced is when there is no data in the queue.

The dequeued data are transmitted via SPI 4.2 to NPU 18 or a device of similar capability.

### Transmit Write Memory Manager (TxWrMemMgr)

The transmit memory is organized as a pool of 240 1 K Byte buffers. The TxWrMemMgr operates at 155 MHz and reads 32 bytes from each SPI 4.2 port in a round robin fashion, retrieves free buffers for requesting ports from the free list, forms the address to write data from the RxMacFifo into the memory by appending the pointer to memory buffer from the allocation list and the curr_wr_ptr and increments it after every write and increments EOP counter (eop_counter) associated with each port after writing in the last byte (Error/Valid EOP). The memory operates at 140 MHz and has a total bandwidth of 35 Gbits for reading and writing the data.

The TxWrMemMgr employees the following basic data structure:
A 240 entry free list buffer pointing to the start fo each of the 240 1 Kbyte buffers (tx_free_list).
One 32 entry allocation list per port (tx_port_ql).
A current write offset for pointing into the current write location in the active buffer for each queue (tx_curr_wr_offset).
A current read offset for pointing into the current read location in the active buffer for each queue (tx_curr_rd_offset).
A Write pointer pointing to written buffers for the 32 entry allocation list (tx_port_buffers_wrt_ptr).
A Read pointer pointing to the read buffers for the 32 entry list (tx_port_buffers_rd_ptr).
An EOP counter (eop_counter) associated with each queue that is incremented whenever a complete packet is written into the memory.
   Functions:

A pop function that pops a buffer form the free_list and returns a pointer to a free buffer to a requesting port.

function pop 0;
{
return (ptr_to_free_buff);
}

A push function that returns used buffers to the free_list from logic.

Function push (ptr_to_used_buffer);
{
return (status):
}

While the present invention has been described in considerable detail and in connection with the preferred embodiment, it will be understood that it is not so limited. On the contrary, it is intended to cover all alternatives, modifications and equivalents as may be included within the spirit and the scope of the invention as defined in the appended claims and all changes which come within the meaning and range of equivalency of the claims are intended to be included therein.

What is claimed is:

1. A method for transmitting data, said method comprising:
receiving said data from at least one source;
determining priority level of said data from vLAN code instructions transmitted with said data;
selectively dropping a portion of said data;
determining available memory resources for the remainder of said data;
selecting the memory resources for recording the remainder of said data;
recording the remainder of said data into said memory resources;
reading the stored data from said memory resources; and
sending said data out of the memory resources.

2. The method of claim 1 wherein said data are Ethernet frames received at 10 (megabits per second) MBps, 100 MBps or 1 Giga Bit per second (GBs).

3. The method of claim 1 wherein said data are free of the virtual Local Area Network (vLAN) code.

4. The method of claim 1 wherein a portion of said data are dropped by Weighted Random Early Detection (WRED) approach.

5. The method of claim 4 wherein no data are dropped at 1 GBps transmission rate.

6. The method of claim 1 wherein said memory resources are partitioned in 1 Kilo byte (KB) blocks.

7. The method of claim 1 wherein said memory operates at 140 Mega Herz (MHz).

8. The method of claim 1 further partitioning said available memory resources into a free list and an allocation list.

9. The method of claim 4 wherein said data are dropped when exceeding a pre-selected threshold level.

10. The method of claim 8 further comprising updating said free list and said allocation list.

11. The method of claim 1 wherein said reading from said memory resources is performed at 155 MHz.

12. The method of claim 1 wherein said reading the stored data further comprises Modified Reduced Deficit Round Robin (MDRR) servicing.

13. A device for transmitting data, said device comprising:
at least one physical (PHY) layer located on ingress side of said device;
at least one media access control (MAC) device;
at least one Reduced Medium-independent Interface (RMII) or Reduced Gigabit medium-Independent Interface (RGMII);
a flow control mechanism
a memory; and
a data sending unit.

14. The device of claim 13 wherein said at least one PHY layer is three PHY layers and wherein said at least one MAC is three MACs.

15. The device of claim 13 wherein said at least one PHY layer is an 8 port device.

16. The device of claim 13 wherein said memory is 480 KB memory.

17. The device of claim 13 wherein said memory is a dual ported Random Acces Memory (RAM).

18. The device of claim 13 wherein said memory is partitioned into 1 KB memory blocks.

19. The device of claim 13 further comprising a System Packet Interface Level 4 Phase 2 (SPI 4.2) device.

20. Device for transmitting data, said device comprising:
means for receiving said data;
means for prioritizing said data;
means for selectively dropping some of said data;
means for writing said data into a memory;
means for reading said written data from said memory; and
means for sending said written data from said memory.
